(19) United States
(12) Patent Application Publication
(10) Pub. No.: US 2021/0216328 A1
(43) Pub. Date: Jul. 15, 2021

(54) DISABLING PORTABLE COMPUTING DEVICE FEATURES USING WRITE-ONCE REGISTER

(71) Applicant: QUALCOMM INCORPORATED, San Diego, CA (US)

(72) Inventors: Christopher Kong Yee Chun, Austin, TX (US); Aditya Susarla, San Diego, CA (US); Ryan Barnett, San Diego, CA (US)

(21) Appl. No.: 16/739,033

(22) Filed: Jan. 9, 2020

(51) Int. Cl. G06F 9/445; G06F 13/20; G06F 9/4401; G06F 21/57

(52) U.S. Cl. CPC G06F 9/44505; G06F 13/20; G06F 2221/034; G06F 21/57; G06F 9/4406

(57) ABSTRACT

Features in a portable computing device (“PCD”) may be selected for disabling by reading configuration information indicating one or more PCD features and corresponding state information. The state information may be written to one or more registers to provide a register with a state indicating that a PCD hardware feature corresponding to the register is either enabled or disabled. Each register may then be locked against a change of state. Each register may have an output coupled to an enabling signal input of a corresponding PCD hardware feature.

### DESCRIPTION OF THE RELATED ART

Portable computing devices (“PCDs”) are becoming necessities for people on personal and professional levels. These devices may include cellular telephones, tablet computers, palmtop computers, portable digital assistants (“PDAs”), portable game consoles, and other portable electronic devices. PCDs commonly contain integrated circuits or systems-on-a-chip (“SoCs”) that include numerous components designed to work together to deliver functionality to a user. For example, an SoC may contain any number of processing engines such as modems, central processing units (“CPUs”) with multiple cores, graphical processing units (“GPUs”), etc. The SoC may be coupled to components within the PCD, such as wireless communication transceivers, cameras, microphones, speakers, etc.

The term “enterprise management” relates to the management of computing technology, such as PCDs, across an organization or enterprise. An organization's PCDs may feature a mode that allows authorized personnel, such as those of an organization's Information Technology (“IT”) department, to secure and manage firmware settings within the organization's PCDs. Commonly, such personnel may create a configuration file that contains firmware feature settings, and provide the configuration file to various PCDs in the organization. A software tool may facilitate the creation and distribution of such a configuration file or package.

PCD settings that may be configured and may include enabling or disabling the operation of selected PCD hardware components, such as cameras, wireless communication transceivers, a docking port, etc. For security, components may be disabled by hardware mechanisms, such as logic gates and switches, rather than by software. These logic gates and switches may be external to the SoC. It would be desirable to provide a more economical and secure way to disable selected PCD components for enterprise management or similar purposes.

### SUMMARY OF THE DISCLOSURE

Systems, methods and computer program products are disclosed for disabling selected features in a portable computing device (“PCD”).

An exemplary method for disabling selected features in a PCD may include reading configuration information indicating one or more PCD hardware features and corresponding state information in response to a first initiation of PCD booting. The method may further include writing the state information to one or more registers to provide a register with a state indicating that a PCD hardware feature corresponding to the register is either enabled or disabled. Each register may have an output coupled to an enabling signal input of a corresponding PCD hardware feature. Each register may also be protected against a change of state subsequent to writing the state information (but before another initiation of PCD booting, which may be characterized as a “second initiation” of PCD booting, and is subsequent to the first initiation of PCD booting). Each PCD hardware feature coupled to a corresponding register having a state indicating disabled is thus disabled in response to a signal coupled from the output of the register to the enabling signal input of the PCD hardware feature.

An exemplary system for disabling selected features in a PCD may include one or more registers and a processor system. An output of each register is coupled to an enabling signal input of a corresponding PCD hardware feature. The processor system may be configured to read configuration information indicating one or more PCD hardware features and corresponding state information in response to a first initiation of PCD booting.

The processor system may further be configured to write the state information to the one or more registers to provide a register with a state indicating that a PCD hardware feature corresponding to the register is either enabled or disabled. Each register may have an output coupled to an enabling signal input of a corresponding PCD hardware feature. Each register may also be protected against a change of state subsequent to writing the state information (but before another initiation of PCD booting, which may be characterized as a “second initiation” of PCD booting, that is subsequent to the first initiation of PCD booting). Each PCD hardware feature coupled to a corresponding register having a state indicating disabled is thus disabled in response to a signal coupled from the output of the register to the enabling signal input of the PCD hardware feature.

Another exemplary system for disabling selected features in a PCD may include means for reading, in response to a first initiation of PCD booting, configuration information indicating one or more PCD hardware features and corresponding state information. The system may further include means for writing, in response to the first initiation of PCD booting, the state information to one or more registers to provide a register with a state indicating that a PCD hardware feature corresponding to the register is either enabled or disabled. Each register may have an output coupled to an enabling signal input of a corresponding PCD hardware feature.

Each register may be protected against a change of state subsequent to writing the state information (but before another initiation of PCD booting, which may be characterized as a “second initiation” of PCD booting, that is subsequent to the first initiation of PCD booting). The system may still further include means for disabling each PCD hardware feature coupled to a corresponding register having a state indicating disabled.

A computer program product for disabling selected features in a PCD may comprise a computer-readable medium having instructions stored thereon. The instructions, when executed on a processor, control a method. The method may include reading configuration information indicating one or more PCD hardware features and corresponding state information in response to a first initiation of PCD booting. The method may further include writing the state information to one or more registers to provide a register with a state indicating that a PCD hardware feature corresponding to the register is either enabled or disabled. Each register may have an output coupled to an enabling signal input of a corresponding PCD hardware feature.

Each register may also be protected against a change of state subsequent to writing the state information (but before another initiation of PCD booting, which may be characterized as a “second initiation” of PCD booting, that is subsequent to the first initiation of PCD booting). Each PCD hardware feature coupled to a corresponding register having a state indicating disabled is thus disabled in response to a signal coupled from the output of the register to the enabling signal input of the PCD hardware feature.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of a PCD that includes a system for disabling selected PCD features, in accordance with exemplary embodiments.

FIG. 2 is a block diagram of a lock register, in accordance with exemplary embodiments.

FIG. 3 is a block diagram of a system for disabling selected PCD features, in accordance with exemplary embodiments.

FIG. 4 is a flow diagram illustrating a method for disabling selected PCD features, in accordance with exemplary embodiments.

FIG. 5 is a flow diagram illustrating another method for disabling selected PCD features, in accordance with exemplary embodiments.

FIG. 6 is a block diagram illustrating circuitry for disabling interface hardware associated with a PCD feature, in accordance with exemplary embodiments.

FIG. 7 is similar to FIG. 6, illustrating another example of the disabling circuitry.

FIG. 8 is similar to FIGS. 6-7, illustrating still another example of the disabling circuitry.

FIG. 9 is similar to FIGS. 6-8, illustrating yet another example of the disabling circuitry.

FIG. 10 is a block diagram of a PCD, in accordance with exemplary embodiments.

### DETAILED DESCRIPTION

The word “exemplary” is used herein to mean “serving as an example, instance, or illustration.” The word “illustrative” may be used herein synonymously with “exemplary.” Any aspect described herein as “exemplary” is not necessarily to be construed as preferred or advantageous over other aspects.

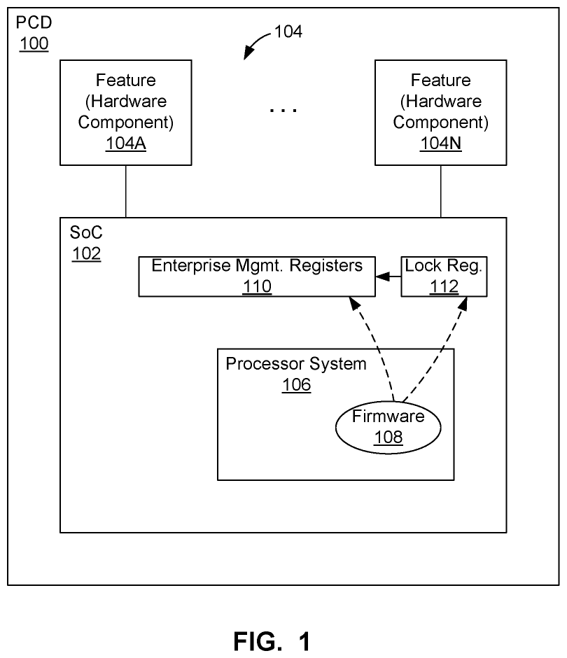

As illustrated in FIG. 1, in an illustrative or exemplary embodiment, a PCD 100 may include a system-on-a-chip (“SoC”) 102 coupled to two or more PCD features or hardware components 104, such as a first hardware component 104A through an Nth hardware component 104N, where further hardware components 104 that may be included are indicated by the ellipsis symbol (“ . . . ”) but are not shown for purposes of clarity. Although hardware components 104A-104N are external to the SoC 102 in the embodiment illustrated in FIG. 1, in other embodiments (not shown) one or more of such PCD features or hardware components may be included in a PCD SoC. The PCD features or hardware components 104 may be of types that are desirable to selectively disable in accordance with common enterprise management (“EM”) principles. Examples of such PCD features or hardware components 104 include, but are not limited to, a docking port (e.g., universal serial bus or “USB” ports), a front camera, a rear camera, an infrared camera, on-board audio processing, a Secure Digital card (“SD card”) port, a WiFi or other wireless local area network (“WLAN”) transceiver, a Bluetooth or other wireless personal area network (“WPAN”) transceiver, an accessory port associated with a keyboard or other PCD accessory, a wideband wireless communication transceiver (e.g., LTE, 5G, etc.), a geolocation (e.g., GPS) receiver, etc.

The SoC 102 includes at least one processor system 106. The processor system 106 may operate in part under the control of firmware 108 to control operations relating to, among other things, selectively disabling PCD hardware components 104. As described below, selectively disabling PCD hardware components 104 may occur in conjunction with power-up or boot-up operations in the PCD 100, and the firmware 108 may control other boot-related functions.

For example, when a PCD 100 having the configuration file is powered up, booted or otherwise receives an authenticated execution instruction, the PCD 100, including the SoC 102 may execute the configuration file. Execution of the configuration file may configure selected device settings or other aspects of the PCD's firmware. The PCD settings that are configured or set in this manner may remain until such time as the PCD 100 is again powered up, booted, etc.

The SoC 102 of a PCD 100 may also include two or more EM registers 110. As described in further detail below, the number of EM registers 110 may correspond to the number of PCD hardware components 104. As also described below, the processor system 106, under control of the firmware 108, may write values to the EM registers 110 to select PCD features or hardware components 104 to disable or enable. The SoC 102 may further include a lock register 112. The processor system 106 may similarly write to the lock register 112. In response, the lock register 112 locks the EM registers 110. That is, the lock register 112 prevents the contents of the EM registers 110 from being over-written with a different value. Each EM register 110 may have an enable input (not individually shown) that receives a lock bit signal that is the output of the lock register 112. When the enable input of an EM register 110 receives a lock bit signal having a state representing “unlocked,” the EM register 110 is capable of storing a value written by the processor system 106. When the enable input of an EM register 110 receives a lock bit signal having a state representing “locked,” the EM register 110 is prevented from storing a value written by the processor system 106. As described below, the lock register 112 may be a type of “write-once” register, meaning that its state cannot be over-written by the processor system 106. After a value has been written to and thus stored in the lock register 112, the lock register 112 can only change its stored value or state in response to a power-on reset (also referred to as a cold reset or cold boot) signal.

One advantage of this system and method is it allows features/functions of a device to be disabled independently using Unified Extensible Firmware Interface (“UEFI”) firmware, which is a protected hardware (H/W) disabling of the device, so that the high level operating system (HLOS) (or any rogue software) cannot enable a feature of the device that was previously disabled with the UEFI firmware. Another advantage is that this disable by UEFI firmware is usually only temporary until the next boot of the device.

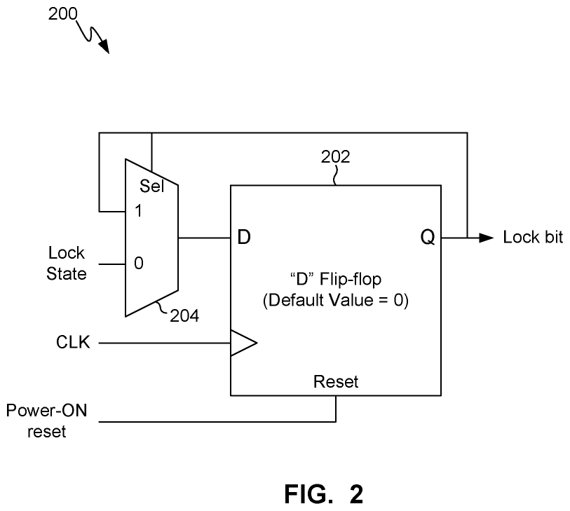

As illustrated in FIG. 2, a lock register 200, which may be an example of the above-described lock register 112 (FIG. 1) may include a D-type flip-flop 202 and a two-input multiplexer 204. The output of the flip-flop 202 is coupled to the selector input of the multiplexer 204 as well as the one of the inputs that the multiplexer 204 selects when its selector input receives a “1” signal value. The input that the multiplexer 204 selects when its selector input receives a “0” signal value receives a “Lock state” signal representing the value to be written to the lock register 200. The output of the multiplexer 202 is coupled to the “D” input of the flip-flop 202. The reset input of the flip-flop 202 receives a clock signal (“CLK”) that is asserted when a write operation occurs.

In response to a power-on reset signal, the flip-flop 202 resets, i.e., sets its stored value or state (“Q”) to zero. Thereafter, in response to the write data signal having a value of “0” when the flip-flop 202 is first clocked (i.e., first after being reset), the flip-flop 202 stores a value of “0”, and in response to the write data signal value having a value of “I” when the flip-flop 202 is first clocked, the flip-flop 202 stores a value of “1”.

Regardless of whether the value of the write data signal is “0” or “1” when the flip-flop 202 is clocked a second time (without an intervening reset), the value stored in the flip-flop 202 does not change. The output of the flip-flop 202 is the lock bit signal described above with regard to FIG. 1. The output of the flip-flop 202 is prevented from changing until such time as the power supplying the lock register 200 is removed, such as upon initiation of a power-on reset or cold boot, which returns the lock register 200 to a default or reset state. It should be understood that the above-described structure or configuration of the lock register 200 is intended only to be exemplary, and various other write-once register configurations will occur readily to one of ordinary skill in the art in view of the descriptions in this specification.

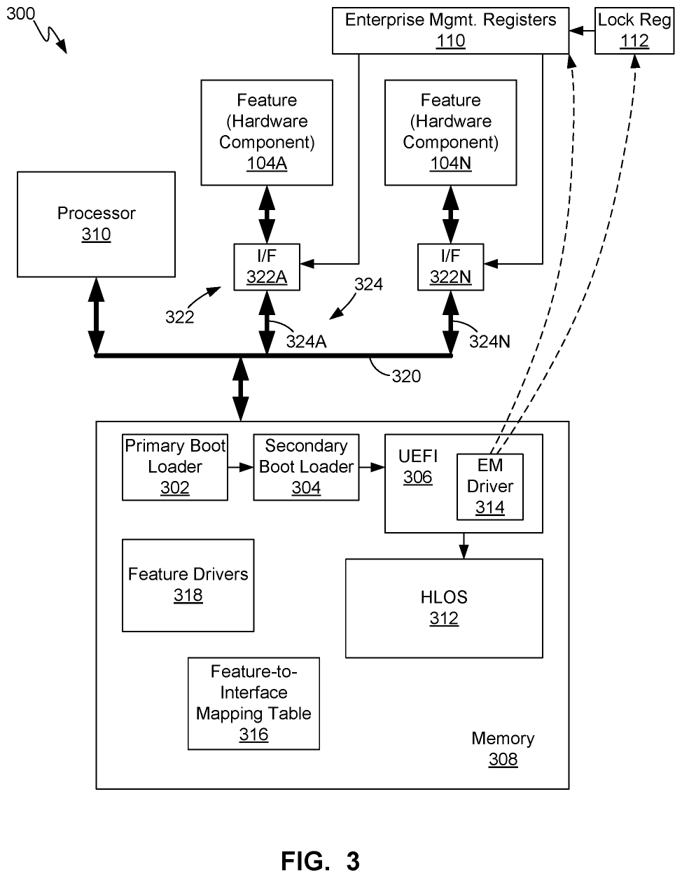

As illustrated in FIG. 3, a system 300, which may be an example of a portion of the above-described PCD 100 (FIG. 1), may further illustrate firmware-related aspects and other operational aspects. For example, the above-described firmware 108 (FIG. 1) may include a primary boot loader 302, a secondary boot loader 304, and Unified Extensible Firmware Interface (“UEFI”) firmware 306. As well understood by one of ordinary skill in the art, UEFI is a specification for software that connects a computing device's firmware to its high-level operating system. For purposes of clarity, these firmware elements, and other software elements discussed below, are conceptually depicted in FIG. 3 as stored or residing in a memory 308. Nevertheless, one of ordinary skill in the art understands that such software elements may not reside in the memory 308 simultaneously or in their entireties, but rather may be loaded into the memory 308 or other memory or memories in portions, for execution (e.g., by a processor 310), in according with well-understood computing principles. The processor 310 and associated processing elements, as configured in operation by software (including firmware), defines a processing system that may control the methods described in this specification.

In the illustrated system 300, initiating PCD booting (e.g., as part of a power-on reset operation) activates the primary boot loader 302. This may be characterized as a “first initiation” of PCD booting. The primary boot loader 302 passes control to the secondary boot loader 304. The secondary boot loader 304 passes control to the UEFI firmware 306. Although three levels of boot firmware, the primary boot loader 302, secondary boot loader 304, and UEFI firmware 306 are illustrated, other embodiments may include fewer or more levels of boot firmware. Among the various operations that occur under control of the UEFI firmware 306 is the loading of a high-level operating system (“HLOS”) 312 into the memory 308.

The UEFI firmware 306 includes an EM driver 314. As described in further detail below, the EM driver 314 is involved in controlling the EM register 110 to select PCD features or hardware components 104 to disable or enable, as conceptually indicated by the broken-line arrows in FIG. 3. As part of PCD booting, the UEFI firmware 306 may load or otherwise provide a feature-to-interface mapping table 316. Various other drivers and software elements, such as feature drivers 318, also may be loaded or otherwise provided as part of PCD booting.

The memory 308 and the processor 310 may be coupled together and to other PCD elements, such as the above-described PCD hardware components 104, via a bus or similar interconnection 320. The system 300 also includes two or more interfaces 322. Each interface 322 may be coupled to a corresponding one of the PCD hardware components 104. Thus, a first interface 322A may be coupled to the first PCD hardware component 104A, an Nth interface 322N may be coupled to the Nth PCD hardware component 104N, etc. Each PCD hardware component 104 and its corresponding interface 322 may together characterize a PCD feature of the type described above with regard to enterprise management. Although the operation of the feature-to-interface mapping table 316 is described below, it may be noted that the feature-to-interface mapping table 316 relates each PCD feature to one of the interfaces 322.

Each interface 322 is configured to control how clock and data signals 324 are conveyed between the corresponding PCD hardware component 104 and a processing system of the PCD (e.g., processor 310, etc.). The clock and data signals 324 may include a first group of one or more clock and data signals 324A through an Nth group of clock and data signals 324N, corresponding to the first interface 322A through the Nth interface 322N.

As the term is used in this specification, an “interface” or “hardware interface” for a PCD hardware component refers to circuitry that controls how one or more clock and data signals required for the PCD hardware component to perform its normal or mission-mode functions are conveyed between the PCD hardware component and a PCD processing system. It should be noted that disabling one of the interfaces 322 prevents the corresponding PCD hardware component 104 from operating in its characteristic or mission-mode manner. For example, a disabled interface corresponding to a camera may prevent the camera from capturing image data or prevent the camera from transferring image data for processing, storage, etc., by the PCD processing system. Disabling an interface corresponding to a camera thus disables the PCD's camera feature.

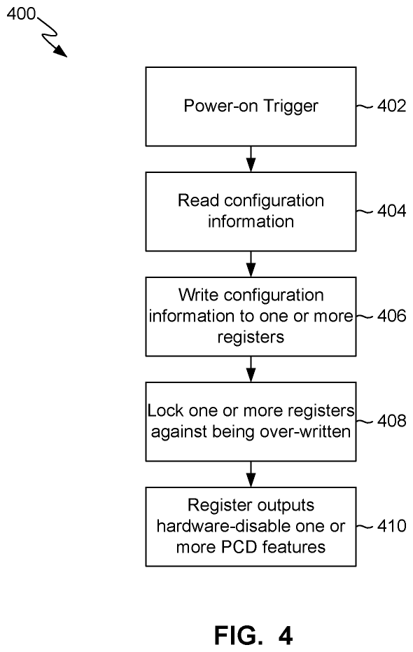

As illustrated in FIG. 4, an exemplary method 400 for disabling selected features in a PCD may be triggered by or performed in response to a power-on reset (“POR”) event (sometimes referred to as a cold boot or hard boot event), as indicated by block 402. A first POR event may include the “first initiation” of PCD booting as described above and below. A subsequent POR event, after the first POR event, may include a “second initiation” of PCD booting and also referred to as a second POR event.

The method 400 may include reading configuration information, as indicated by block 404. The configuration information may identify or indicate one or more PCD hardware features and corresponding state information. The state information may indicate that a corresponding PCD hardware feature is to be disabled (i.e., the feature is to be placed into a disabled state) or, alternatively, may indicate that a corresponding PCD hardware feature is to be enabled (i.e., the feature is to be placed into an enabled state).

As indicated by block 406, the method 400 may further include writing the state information to one or more registers, thereby setting each such register to indicate the disabled or enabled state. As indicated by block 408, the method 400 may include locking the registers, i.e., preventing the registers from being over-written. The outputs of the registers, which may be locked, may disable one or more PCD hardware features in this manner, as indicated by block 410. Note that if instead of a POR event, a soft reset event (i.e., during which power remains supplied to the registers and locking circuitry) were to occur, the registers could not be over-written in the manner described above with regard to block 406 if the registers had been locked before the soft reset event.***

The EM registers 110 described above with regard to FIGS. 1-3 are examples of the registers to which the method 400 relates. Each PCD hardware component 104 that is coupled to a corresponding EM register 110 having a state indicating disabled is thus disabled. Examples of the manner in which a signal coupled from the output of an EM register 110 to an enabling signal input of the PCD hardware component 104 are described below. Note that in the exemplary embodiment described above with regard to FIG. 3 the output of an EM register 110 may be coupled to a corresponding PCD hardware component 104 via a corresponding one of the above-described interfaces 322.

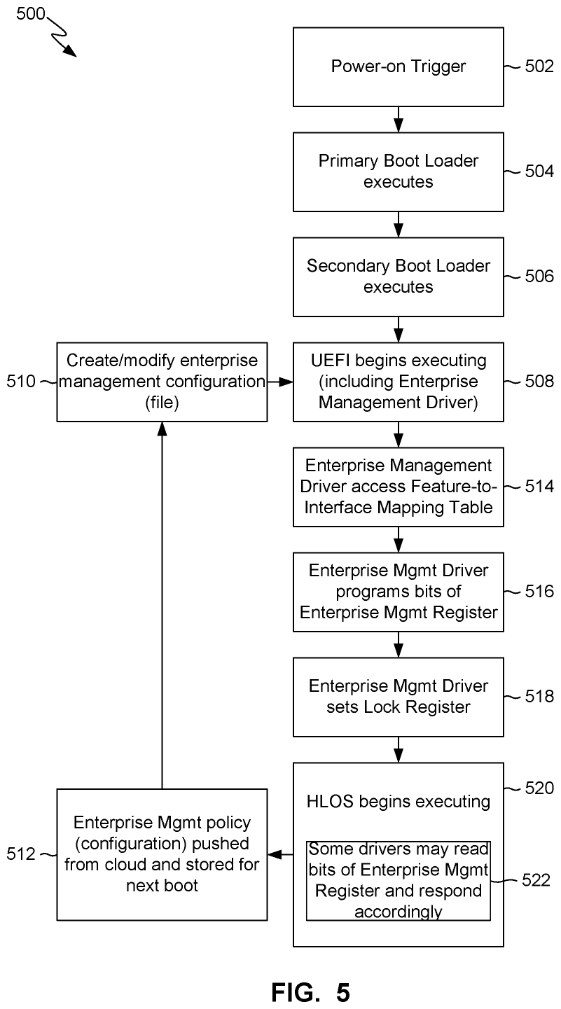

As illustrated in FIG. 5, an exemplary method 500 for disabling selected features in a PCD may be triggered by or performed in response to a POR event, as indicated by block 502. The POR initiates PCD booting. In response to the initiating of PCD booting, the primary boot loader 302 (FIG. 3) executes and passes control to the secondary boot loader 304 (FIG. 3), as indicated by block 504. The secondary boot loader 304 begins executing, as indicated by block 506. The secondary boot loader 304 then loads and activates the UEFI firmware 306 (FIG. 3), which begins executing, as indicated by block 508.

The UEFI firmware 306 may read configuration information from, for example, a file. As indicated by block 510, such a configuration file may be created, for example, by an organization's IT department or other personnel responsible for enterprise management across the organization's PCDs. As described above, such a configuration file may list some or all of the PCD hardware components 104 (FIGS. 1, 3). For each listed PCD hardware component 104, the configuration file may indicate whether that PCD hardware component 104 or corresponding PCD hardware feature is to be disabled.

Although not shown, the creation of a configuration file may be aided by a software tool on a management computer or similar device. A list of PCD features may be displayed, and the user may check boxes to indicate which PCD features to enable or disable. The configuration file may be downloaded to the PCD in any manner and at any time, such as by being pushed from a cloud system (not shown), as indicated by block 512. In an embodiment in which a configuration policy or file is pushed from a cloud system to the PCD, the file may be provided directly to the PCD or, alternatively, to the above-mentioned management device for modification prior to being downloaded to the PCD.

In the exemplary embodiment described in this specification, the hardware components 104 power up in a default state of enabled. Therefore, in this embodiment the configuration file may, but does not need to, indicate hardware components 104 to be placed into the enabled state; rather the configuration file need only indicate which hardware components 104 are to be placed into the disabled state. That is, in this exemplary embodiment hardware components 104 to be enabled do not need to be, but may be, actively enabled by the method 500.

In another embodiment (not shown), in which the hardware components power up in a default state of disabled, the configuration file may, but does not need to, indicate hardware components to be placed into the disabled state; rather, the configuration file need only indicate hardware components to be placed into the enabled state. That is, in such other embodiments hardware components to be disabled do not need to be, but may be, actively disabled by the method. Nevertheless, a configuration file may indicate both hardware components to be placed into the disabled state and hardware components to be placed into the enabled state.

As indicated by block 514, the UEFI firmware's EM driver 314 (FIG. 3) may, based on the configuration information, access the feature-to-interface mapping table 316 (FIG. 3) to determine which interfaces 322 and thus which EM registers 110 correspond to the hardware components 104 to be actively enabled or disabled. As indicated by block 516, the EM driver 314 may then program or set the states of those EM registers 110.

For example, as described above with regard to FIG. 2, each EM register 110 may store one bit to indicate a state of disabled (e.g., “0”) or enabled (e.g., “1”). As indicated by block 518, the EM driver 314 may then set the state of the lock register 112 to prevent the states of the EM registers 110 from being over-written. As the EM registers 110 and the lock register 112 may occupy a portion of the processing system's address space (i.e., memory map), the EM registers 110 and the lock register 112 may be written to in the same manner as other locations in the processing system's address space.

The UEFI firmware 306 (FIG. 3) may load one or more feature drivers 318 (FIG. 3), such as, for example, Peripheral Component Interconnect express (“PCIe”) driver, a Universal Serial Bus (“USB”) driver, a Secure Digital Card Controller (“SDCC”) driver, etc. As the UEFI firmware 306 is aware from the configuration information of which features are to be disabled, the UEFI firmware 306 may refrain from loading any feature driver 318 that supports a feature to be disabled. Alternatively, or in addition, one or more of the feature drivers 318 may be configured to read the EM registers 110 and, if the state of an EM register 110 is disabled, refrain from initializing, or de-initialize portions of the corresponding hardware component 104. It should be understood that while the processing system may write to the EM registers 110 in the manner described above (i.e., under control of the EM driver 314), the processing system (e.g., under control of a feature driver 318) may also read the states of the EM registers 110.

As indicated by block 520, a high-level operating system (“HLOS”) that has been loaded as part of the booting process may begin executing. As indicated by block 522, other driver software (i.e., other than the feature drivers 318) may configure the processing system to read the EM registers 110 and perform an action based on the contents read from the EM registers 110. For example, such a driver may cause the processing system to unload the driver in response to reading that the state of an EM register 110 corresponding to the PCD feature serviced by the driver is disabled.

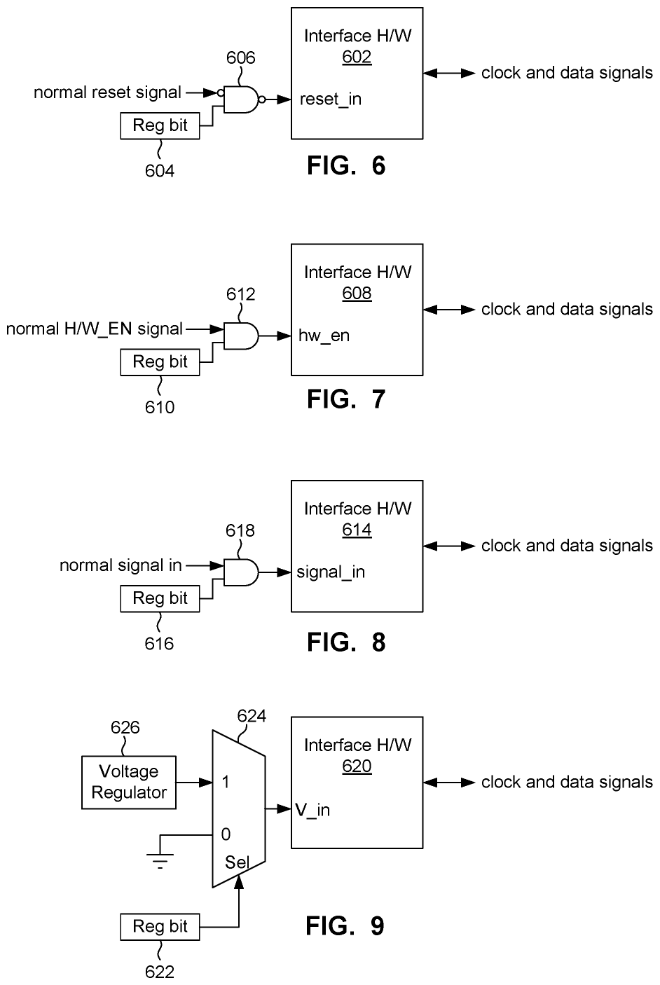

As illustrated in FIGS. 6-8, an EM register output may be coupled in various ways to an enabling input of one of the above-described interfaces 322 (FIG. 3). As used in this specification, the term “enabling input” refers to an input configured to receive a signal that the interface 322 requires to enable it to operate in its normal or mission-mode manner and thereby enables the corresponding hardware component 104 to operate in its normal or mission-mode manner.

In the example shown in FIG. 6, the enabling signal input of an interface 602, which may be an example of one of the interfaces 322 (FIG. 3), is a reset input (“reset_in”). A register bit 604, which may be an example of the output of one of the EM registers 110, may be coupled to the reset input via logic (hardware) 606. The logic 606 may be, for example, a two-input NAND gate having one inverted input. The logic 606 is configured to disable the interface 602 when either the register bit 604 indicates the disabled state or a normal (i.e., mission-mode) reset signal similarly indicates that the corresponding hardware component 104 (not shown in FIG. 6) is to be disabled.

The normal reset signal is a signal that a processor system may conventionally (i.e., absent a system or method for disabling selected PCD features as described in this specification) generate to enable or disable the corresponding hardware component 104. Holding the signal at the reset input at a value indicating a reset state disables the interface 602 from operating.

In the example shown in FIG. 7, the enabling signal input of an interface 608, which may be an example of one of the interfaces 322, is a hardware enable input (“hw_en”). A register bit 610, which may be an example of the output of one of the EM registers 110, may be coupled to the hardware enable input via logic (hardware) 612. The logic 612 may be, for example, an AND gate. The logic 612 is configured to disable the interface 608 when either the register bit 610 indicates the disabled state or a normal (i.e., mission-mode) hardware enable signal similarly indicates that the corresponding hardware component 104 (not shown in FIG. 7) is to be disabled.

The normal hardware enable signal is a signal that a processor system may conventionally (i.e., absent a system or method for disabling selected PCD features as described in this specification) generate to enable or disable the corresponding hardware component 104. Holding the signal at the hardware enable input at a value indicating a disabled state disables the interface 608 from operating.

In the example shown in FIG. 8, the enabling signal input of an interface 614, which may be an example of one of the interfaces 322, is a critical signal input (“signal_in”). A critical signal may be any signal that the interface 614 requires to enable it to operate in its normal or mission-mode manner. A register bit 616, which may be an example of the output of one of the EM registers 110, may be coupled to the critical signal input via logic (hardware) 618. The logic 618 may be, for example, an AND gate. The logic 618 is configured to disable the interface 614 when either the register bit 616 indicates the disabled state or a normal (i.e., mission-mode) signal has a state preventing the corresponding hardware component 104 (not shown in FIG. 8) from operating. The normal signal is a signal that may conventionally (i.e., absent a system or method for disabling selected PCD features as described in this specification) be provided in a PCD so that the interface 614 is able to support operation of the corresponding hardware component 104.

In the example shown in FIG. 9, the enabling signal input of an interface 620, which may be an example of one of the interfaces 322, is a power supply input (“V_in”). The interface 620 requires a power signal (e.g., a certain voltage level) to be supplied to the power supply input to enable it to operate in its normal or mission-mode manner. A register bit 622, which may be an example of the output of one of the EM registers 110, may be coupled to the power supply input via logic (hardware) 624. The logic 624 may be, for example, a two-input power multiplexer having one input coupled to a voltage regulator 626, the other input coupled to ground, and the selector bit coupled to the register bit 622. The logic 624 is configured to disable the interface 620 by selecting the ground input when the register bit 622 indicates the disabled state.

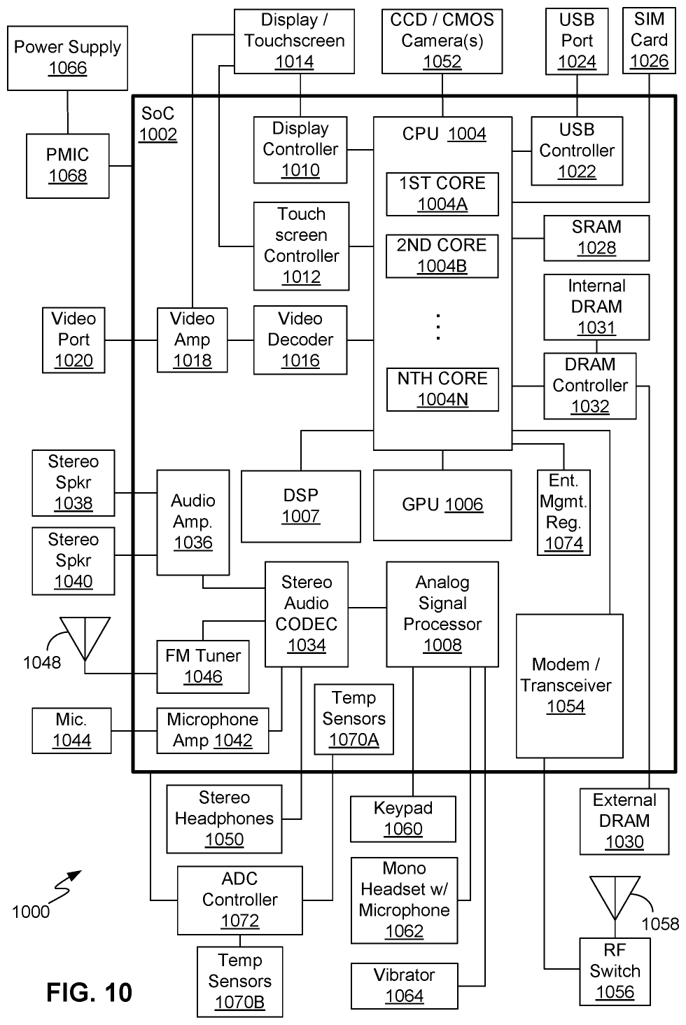

As illustrated in FIG. 10, exemplary embodiments of systems and methods for sensor data storage may be embodied in a PCD 1000. The PCD 1000 includes an SoC 1002. The SoC 1002 may include a CPU 1004, a GPU 1006, a DSP 1007, an analog signal processor 1008, or other processors. The CPU 1004 may include multiple cores, such as a first core 1004A, a second core 1004B, etc., through an Nth core 1004N.

A display controller 1010 and a touchscreen controller 1012 may be coupled to the CPU 1004. A touchscreen display 1014 external to the SoC 1002 may be coupled to the display controller 1010 and the touchscreen controller 1012. The PCD 1000 may further include a video decoder 1016 coupled to the CPU 1004. A video amplifier 1018 may be coupled to the video decoder 1016 and the touchscreen display 1014. A video port 1020 may be coupled to the video amplifier 1018. A universal serial bus (“USB”) controller 1022 may also be coupled to CPU 1004, and a USB port 1024 may be coupled to the USB controller 1022. A subscriber identity module (“SIM”) card 1026 may also be coupled to the CPU 1004.

One or more memories may be coupled to the CPU 1004. The one or more memories may include both volatile and non-volatile memories. Examples of volatile memories include static random access memory (“SRAM”) 1028 and dynamic RAMs (“DRAM”s) 1030 and 1031. Such memories may be external to the SoC 1002, such as the DRAM 1030, or internal to the SoC 1002, such as the DRAM 1031. A DRAM controller 1032 coupled to the CPU 1004 may control the writing of data to, and reading of data from, the DRAMs 1030 and 1031. In other embodiments, such a DRAM controller may be included within a processor, such as the CPU 1004.

A stereo audio CODEC 1034 may be coupled to the analog signal processor 1008. Further, an audio amplifier 1036 may be coupled to the stereo audio CODEC 1034. First and second stereo speakers 1038 and 1040, respectively, may be coupled to the audio amplifier 1036. In addition, a microphone amplifier 1042 may be coupled to the stereo audio CODEC 1034, and a microphone 1044 may be coupled to the microphone amplifier 1042. A frequency modulation (“FM”) radio tuner 1046 may be coupled to the stereo audio CODEC 1034. An FM antenna 1048 may be coupled to the FM radio tuner 1046. Further, stereo headphones 1050 may be coupled to the stereo audio CODEC 1034. Other devices that may be coupled to the CPU 1004 include one or more digital (e.g., CCD or CMOS) cameras 1052, such as a front-facing camera and a rear-facing camera with respect to opposing sides of a PCD housing (not shown).

A modem or RF transceiver 1054 may be coupled to the analog signal processor 1008. An RF switch 1056 may be coupled to the RF transceiver 1054 and an RF antenna 1058. In addition, a keypad 1060, a mono headset with a microphone 1062, and a vibrator device 1064 may be coupled to the analog signal processor 1008.

A power supply 1066 may be coupled to the SoC 1002 via a power management integrated circuit (“PMIC”) 1068. The power supply 1066 may include a rechargeable battery or a DC power supply that is derived from an AC-to-DC transformer connected to an AC power source.

The SoC 1002 may have one or more internal or on-chip thermal sensors 1070A and may be coupled to one or more external or off-chip thermal sensors 1070B. An analog-to-digital converter (“ADC”) controller 1072 may convert voltage drops produced by the thermal sensors 1070A and 1070B to digital signals.

The touch screen display 1014, the video port 1020, the USB port 1024, the camera 1052, the first stereo speaker 1038, the second stereo speaker 1040, the microphone 1044, the FM antenna 1048, the stereo headphones 1050, the RF switch 1056, the RF antenna 1058, the keypad 1060, the mono headset 1062, the vibrator 1064, the thermal sensors 1050B, the ADC controller 1052, the PMIC 1068, the power supply 1066, the DRAM 1030, and the SIM card 1026 are external to the SoC 1002 in this exemplary embodiment. It will be understood, however, that in other embodiments one or more of these devices may be included in such an SoC.

The SoC 1002 may include an EM register 1074, which may be an example of the above-described EM register 110 (FIGS. 1, 3). The CPU 1004 (or a core thereof), GPU 1006, or DSP 1007, operating with a PCD memory, such as the DRAM 1030 or 1031, or the SRAM 1028, and associated components may be an example of the above-described processor system 106 (FIG. 1). The above-described methods 400 (FIG. 4) and 500 (FIG. 5) may be controlled or achieved through the execution of the above-described firmware or software in such a processing system. Any such PCD memory or other memory or storage medium having the firmware or software or a portion thereof stored thereon in computer-readable form may be an example of a “computer program product,” “computer-readable medium,” etc., as such terms are understood in the patent lexicon.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for disabling selected features in a portable computing device (“PCD”), comprising:
receiving, in response to a first initiation of PCD booting, configuration information indicating one or more PCD hardware features and corresponding state information;
changing, in response to the first initiation of PCD booting, the state information in one or more registers to indicate a disabled or enabled state of a corresponding PCD hardware feature;
locking the state information in each register from being reset while the PCD is in an operational state; and
disabling each PCD hardware feature coupled to a corresponding register having a hardware disabled state status by coupling a signal from an output of the register to the enabling signal input of the PCD hardware feature.

2. The method of claim 1, wherein receiving the configuration information further comprises reading of the configuration information by the processor system.

3. The method of claim 1, wherein changing the state information comprises writing of the state information by the processor system to the one or more registers.

4. The method of claim 1, wherein the locking the state information in each register further comprises locking of the state information in each register by the processor system.

5. The method of claim 1, wherein locking comprises protecting each register against being reset to a default state unless a power-on reset of the PCD occurs.

6. The method of claim 1, further comprising:
reading, by the processor system in response to the first initiation of PCD booting, a feature-to-interface table relating each of the one or more PCD hardware features to a corresponding hardware interface;
wherein changing the state information in the one or more registers comprises writing the state information based on results of reading the feature-to-interface table.

7. The method of claim 1, wherein:
each PCD hardware feature has a corresponding hardware interface configured to interface one or more clock signals and one or more data signals between the PCD hardware feature and a processor system of the PCD; and
coupling a signal comprises coupling the signal to the enabling signal input of the hardware interface of the corresponding PCD hardware feature.

8. The method of claim 7, wherein logic hardware couples the output of the register to the enabling signal input, the logic hardware configured to pass a normal operational enabling signal to the enabling signal input when the state of the register indicates enabled and to override the normal operational enabling signal from affecting the enabling signal input when the state of the register indicates disabled.

9. The method of claim 1, wherein the enabling signal input is one of: a reset input; an enable input; a critical interface signal input; and a power input.

10. The method of claim 1, further comprising refraining, by the processor system, from loading a software driver for any PCD hardware feature coupled to a corresponding register having a state indicating disabled.

11. The method of claim 1, further comprising:
reading the one or more registers to determine the state of each register; and
refraining from initializing any PCD hardware feature corresponding to a register having a state indicating disabled.

12. A system for disabling selected features in a portable computing device (“PCD”), comprising:
one or more registers;
a processor system configured to:
read, in response to a first initiation of PCD booting, configuration information indicating one or more PCD hardware features and corresponding state information;
write, in response to the first initiation of PCD booting, the state information in the one or more registers to indicate a disabled or enabled state of a corresponding PCD hardware feature; and
lock each register against a change of state subsequent to writing the state information and before a second initiation of PCD booting subsequent to the first initiation of PCD booting; and
coupling circuitry configured to couple an output of the register to an enabling signal input a corresponding PCD hardware feature, the coupling circuitry configured to disable each PCD hardware feature coupled to a corresponding register having hardware disabled state status by controlling a signal provided to the enabling signal input of the PCD hardware feature.

13. The system of claim 12, wherein the coupling circuitry is configured to pass a normal operational enabling signal to the enabling signal input when the state of the register indicates enabled and to override the normal operational enabling signal from affecting the enabling signal input when the state of the register indicates disabled.

14. The system of claim 12, wherein each register is protected against being reset to a default state unless a power-on reset of the PCD occurs.

15. The system of claim 12, wherein the processor system is further configured to:
read, in response to the first initiation of PCD booting, a feature-to-interface table relating each of the one or more PCD hardware features to a corresponding hardware interface;
wherein the processor system is configured to write the state information in the one or more registers by being configured to write the state information based on results of reading the feature-to-interface table.

16. The system of claim 12, wherein:
each PCD hardware feature has a corresponding hardware interface configured to interface one or more clock signals and one or more data signals between the PCD hardware feature and a processor system of the PCD; and
the coupling circuitry is configured to control a signal provided to the enabling signal input of the hardware interface of the corresponding PCD hardware feature.

17. The system of claim 15, wherein the coupling circuitry is configured to pass a normal operational enabling signal to the enabling signal input when the state of the register indicates enabled and to override the normal operational enabling signal from affecting the enabling signal input when the state of the register indicates disabled.

18. The system of claim 12, wherein the enabling signal input is one of: a reset input; an enable input; a critical interface signal input; and a power input.

19. The system of claim 12, wherein the processor system is further configured to refrain from loading a software driver for any PCD hardware feature coupled to a corresponding register having a state indicating disabled.

20. A system for disabling selected features in a portable computing device (“PCD”), comprising:
means for reading, in response to a first initiation of PCD booting, configuration information indicating one or more PCD hardware features and corresponding state information;
means for writing, in response to the first initiation of PCD booting, the state information in one or more registers to indicate a disabled or enabled state of a corresponding PCD hardware feature;
means for locking each register against a change of state subsequent to writing the state information and before a second initiation of PCD booting subsequent to the first initiation of PCD booting; and
means for disabling each PCD hardware feature coupled to a corresponding register having a hardware disabled state status.

21. The system of claim 20, wherein the means for locking protects each register against being reset to a default state unless a power-on reset of the PCD occurs.

22. The system of claim 20, further comprising:
means for reading, in response to the first initiation of PCD booting, a feature-to-interface table relating each of the one or more PCD hardware features to a corresponding hardware interface;
wherein the means for writing the state information to the one or more registers comprises means for writing the state information based on results of reading the feature-to-interface table.

23. The system of claim 20, wherein:
each PCD hardware feature has a corresponding hardware interface configured to interface one or more clock signals and one or more data signals between the PCD hardware feature and a processor system of the PCD; and
the means for disabling the PCD hardware feature comprises means for controlling a signal provided to the enabling signal input of the hardware interface of the corresponding PCD hardware feature.

24. The system of claim 23, wherein the means for disabling comprises means for passing a normal operational enabling signal to the enabling signal input when the state of the register indicates enabled and means for overriding the normal operational enabling signal from affecting the enabling signal input when the state of the register indicates disabled.

25. The system of claim 20, wherein the enabling signal input is one of: a reset input, an enable input; a critical interface signal input, and a power input.

26. A computer program product for disabling selected features in a portable computing device (“PCD”), the computer program product comprising a computer-readable medium having stored thereon instructions that when executed on a processor control a method comprising:
receiving, in response to a first initiation of PCD booting, configuration information indicating one or more PCD hardware features and corresponding state information;
changing, in response to the first initiation of PCD booting, the state information in one or more registers to indicate a disabled or enabled state of a corresponding PCD hardware feature;
locking the state information in each register from being reset while the PCD is in an operational state; and
disabling each PCD hardware feature coupled to a corresponding register having a hardware disabled state status by coupling a signal from the output of the register to the enabling signal input of the PCD hardware feature.

27. The computer program product of claim 26, wherein receiving the configuration information further comprises reading of the configuration information by the processor.

28. The computer program product of claim 26, wherein changing the state information comprises writing of the state information by the processor to the one or more registers.

29. The computer program product of claim 26, wherein the locking the state information in each register further comprises locking of the state information in each register by the processor.

30. The computer program product of claim 26, wherein the locking comprises protecting each register against being reset to a default state unless a power-on reset of the PCD occurs.
